(19) United States
(12) Patent Application Publication
(10) Pub. No.: US 2023/0404317 A1
(43) Pub. Date: Dec. 21, 2023

(54) MECHANICAL BREWING UNIT

(71) Applicant: CUP&CINO KAFFEESYSTEM-VERTRIEB GMBH & CO. KG, Hövelhof (DE)

(72) Inventor: Frank Josef Paul EPPING, Hövelhof (DE)

(73) Assignee: CUP&CINO KAFFEESYSTEM-VERTRIEB GMBH & CO. KG, Hövelhof (DE)

(21) Appl. No.: 18/069,309

(22) Filed: Dec. 21, 2022

(30) Foreign Application Priority Data
Aug. 11, 2020 (EP) 20190510.6

(51) Int. Cl. A47J 31/24; A47J 31/44

(52) U.S. Cl. CPC A47J 31/24; A47J 31/44

(57) ABSTRACT

A brewing unit for an espresso and coffee machine includes a frame structure, a hand lever which is mounted on the frame structure so as to be rotatable about an axis of rotation, and a brewing piston element which is operatively connected to the hand lever by means of a lever mechanism, whereby the brewing piston element, coupled to the movement of the hand lever, is movable between a first position and at least one second position along a vertical axis. The brewing piston element includes a distributor sieve which, in the second position of the brewing piston element, and together with a filter support which can be inserted into a holding device, delimits a brewing chamber, and hot pressurized brewing water is able to be introduced into the brewing chamber through the distributor sieve; the brewing piston element also includes a piston rod to which the distributor sieve is connectible. The brewing unit further includes locking means which are designed to hold the brewing piston element in at least one adjustable position along the vertical axis.

### BACKGROUND AND SUMMARY

The present invention relates to a mechanical brewing unit for use in an espresso or coffee machine. The present invention likewise relates to an espresso and coffee machine comprising such a mechanical brewing unit.

Espresso and coffee machines can be differentiated according to their degree of automation. Accordingly, there is a group of so-called “portafilter machines” or “semi-automatic machines”, the group of “fully automatic machines” and various variants in between, also referred to as hybrid machines. In the case of semi-automatic espresso and coffee machines, the preparation of one or more cups of coffee or espresso involves one or more steps which are not fully automatic, but can be carried out individually by an operator. In particular, a portafilter machine comprises a removable portafilter into which a desired amount of around coffee powder can be loaded and compacted to produce a uniformly high and uniformly compacted coffee bed. It is up to the barista to determine the type, quantity and grind of coffee powder, the type of brewing sieve used and the force to be applied for tamping (pressing). The filled brewing sieve or the portafilter with the inserted brewing sieve can then be clamped in a holder provided in the coffee machine. The brewing water can be pressed through the pressed coffee powder by means of a hand lever that can be operated by the barista. Variants are known in which this is supported by a coupled hydraulic system and/or a toggle lever system. The coffee quality achievable with such a machine is very high in terms of aroma and crema, but depends to a large extent on the skills and intuition of the operator. Only an experienced barista can achieve a largely consistent high brewing result using such a technically simple portafilter machine.

To name another variant, hybrid machines are known in which the portafilter equipped with a brewing sieve can be inserted into a provided portafilter holder, but the brewing sieve is filled automatically in the coffee machine, i.e. ground coffee from an integrated coffee grinder are dosed into the brewing sieve. The removal of the coffee grounds or coffee cake after coffee production can then be carried out manually. The movement of the brewing piston during the brewing process can be largely automated by means of a drive unit.

Fully automatic machines achieve an even higher degree of automation, so that all steps of coffee production are carried out automatically according to the type of coffee selected by an operator. Stable qualities can be achieved, but there is no possibility for an operator to directly influence the process.

The production of espresso requires the observance of a series of parameters, which are defined by the corresponding standard. This specifies for an espresso that 22.5 to 27.5 ml of hot water at a temperature between 88° C. and 94° C. is pressed through 6.5 to 7.5 g of uniformly compressed ground coffee under pressure of 8 to 10 bar during a cycle time of 20 to 30 seconds. Furthermore, it is known that the quality produced is also highly dependent on the flow resistance of the ground coffee, which in turn is influenced by the degree of grinding, the height of the ground coffee in the brewing sieve, and the degree of compaction of the ground coffee filled in. The high pressures involved in the production of espresso require that the construction of an espresso machine be of a certain robustness and, in particular, that tools be available to achieve and maintain the high pressures during the brewing process.

EP 2 811 876 describes a coffee machine associated with hybrid machines with a filter support that can be inserted into a holder provided for the brewing process. Furthermore, a distributor sieve element is provided, comprising a distributor sieve which delimits a brewing chamber with the filter support, and whereby hot, pressurized water is introduced into the brewing chamber through the distributor sieve. The distribution sieve element can be moved back and forth between a first position, in which the filter support is open and can be filled with ground coffee from an integrated coffee grinder by means of appropriate devices, and a second position, in which the distribution sieve element closes the filter support in a pressure-tight manner. An electrically or hydraulically operated drive unit is provided for moving the distributor sieve element between the first and the second position.

Known from CN 201578093 is a coffee machine in which the brewing piston can be moved into a brewing position by means of a manually actuated lever in operative connection with a toggle lever mechanism. By means of a complicated system of a sliding guide, the brewing piston is moved not only vertically, but also horizontally, in order to be able to be inserted into a filter support, into which ground coffee is metered at an integrated mill outlet. The toggle mechanism can be moved beyond a maximum extension to be fixed in a stop position in which the brewing piston is held against the force applied during the pressurized brewing operation.

Known from EP 0 634 903 is a brewing device for a household espresso machine, in which the portafilter or filter support can be pivoted or moved horizontally into a filling position for filling or into a brewing position. The brewing device comprises a piston which can be manually moved vertically against an actuating force into a locking position, which piston is insertable into the filter support in the brewing position and forms a pressure chamber with it. A locking lever is thereby provided, which forms a releasable friction lock with the piston rod in order to position the piston rod almost steplessly by means of a clamping connection.

Based on this prior art, it is desirable to provide a mechanical brewing unit for use in espresso and coffee machines, which can be used as a module in different types of espresso and coffee machines. In particular, the brewing unit according to an aspect of the invention with a mechanism able to be actuated by the operator offers the possibility of being directly and immediately involved in the production of an espresso or coffee of high quality, creating a personalized experience. Furthermore, the mechanical brewing unit according to an aspect of the invention also allows a sufficiently simple operation, for which no high effort is required to generate and maintain the pressure to produce an espresso.

The brewing unit for an espresso and coffee machine according to an aspect of the invention comprises a frame structure, a hand lever which is rotatably or pivotally mounted on the frame structure, and a brewing piston element which is operatively connected to the hand lever by means of a lever mechanism, the brewing piston element being movable between a first position and at least one second position along a vertical axis. Further, the brewing piston element comprises a distributor sieve which, in the second position of the brewing piston element, delimits a brewing space with a filter support inserted in a holder, and hot pressurized brewing water is able to be introduced into the brewing space through the distributor sieve, and a piston rod to which the distributor sieve can be connected. Furthermore, locking means are provided, which are designed to hold the brewing piston element in at least one adjustable position along the vertical axis or to release it from an adjustable stop position.

In particular the distributor sieve is releasably connectible to the piston rod of the brewing piston element by means of a screw connection. Sealing means are provided on the brewing piston element so that it closes the brewing chamber in a pressure-tight manner when it is repeatedly inserted into the filter support. The brewing piston element is movable back and forth between a first position, in which the filter support is open and ground coffee can be filled into a brewing sieve accommodated in the filter support, and a second position. In the second position of a press position, the brewing chamber is sealed in a pressure-tight way. A coupling between the hand lever, the lever mechanism and the brewing piston element, as well as the locking means, provides the operator with a manual handling of the espresso and coffee production, whereby in particular through the locking means occurring high pressure is maintained.

The locking means are provided to lock the brewing piston element almost steplessly in adjustable positions along the vertical axis and to release it again from this position. In particular, the brewing piston element is held in the second position, which corresponds to the pressing position of the brewing piston element.

The hand lever gives the operator the impression of direct involvement in the production process, as is perceived as advantageous with semi-automatic machines, although individual steps in the coffee production process can also run at least partially automatically. In this way a consistent quality of the coffee produced is ensured.

For example, the movement of the hand lever and the included lever mechanism can be coupled to activation of a releasable lock that activates or deactivates a metering device for filling ground coffee powder into the opened filter support. When the lock is released, a defined amount of freshly ground coffee powder enters the provided filter support. In particular, the movement of the hand lever and the coupled lever mechanism causes a defined movement of the brewing piston element so that the coffee powder introduced into the filter support is compressed and the brewing piston element is brought into brewing position for a brewing process.

In the frame structure of the brewing unit, a pivot axis is able to be mounted, on which the hand lever is arranged, so that it is rotatably or pivotably connected to the frame structure. The hand lever can be in the form of a fork, the legs of which are rotatably mounted on both sides of the frame structure. The hand lever can be equipped with a handle at a proximal end and is rotatably or pivotably mounted on the frame structure at a distal end. In particular, the hand lever may be pivotable against a spring force, as will be explained.

The lever mechanism operatively connected to the hand lever comprises at least a first connecting element and a second connecting element. A first end of the first connecting element is received at the axis of rotation, so that a movement of the hand lever is transmitted to the first connecting element. A second end of the first connecting element is connected to a first end of the second connecting element by means of a first articulation, whereby a second end of the second connecting element is connected to the brewing piston element by means of a second articulation. When the hand lever moves vertically from a start position, e.g. an upper position or rest position, downwards to an end position, the lever mechanism transfers the movement of the hand lever to the brewing piston element so that this is also guided vertically downwards. Alternatively, the start position can also be a lower position and the end position an upper position, i.e. the hand lever is actuated in the opposite direction to the movement of the brewing piston element.

In one embodiment, the movement of the hand lever out of the start position takes place against a resistance force, for example starting from a return element designed as a spring element or a hydraulic system. Alternatively, the resistance force can be generated by a pneumatic system, in particular by means of a gas pressure spring, which is particularly suitable for maintaining the corresponding resistance force at a constantly high level over a long period of time and even during intensive use, and which also requires only a small installation space. A pneumatic or hydraulic system can be supplemented by a valve which, in particular, detects a start position of the hand lever to prevent incorrect manipulation. The restoring force generated by this valve enables the hand lever to be automatically returned to the start position when it is released. The first connection element and the second connection element, the first articulation and the second articulation as well as the frame structure are designed in such a way that high forces can be absorbed.

In one embodiment, the vertical movement of the brewing piston element can be guided so that a stable movement is possible. In this way, the user can individually execute the movement of the hand lever at different speeds. The movement of the hand lever can be adjusted at the factory with regard to the resistance force and the release or blocking. In particular, the hand lever is not released until the grinding process and filling into the provided brewing sieve has been completed. The brewing piston element, which is operatively connected to the hand lever and the lever mechanism, can preferably be moved not only from the first position to the second position, but also to at least one intermediate position in which the coffee powder filled into the brewing sieve can be pressed in a defined manner. The force to be applied by the brewing piston element for compressing the ground coffee filled in is preferably adjustable. For example, an adjustable spring element can be provided for setting or limiting the tamping force, which is able to be transmitted to the brewing piston element by means of the hand lever. Thus, when the brewing piston element contacts the material to be ground, the tamping force can be built up in a defined manner by means of the spring element, also referred to as the tamping spring. Depending on the quantity in the brewing sieve, or on the height of the coffee cake, different positions can be approached. When the spring force of the adjustable spring element is reached, the further pressing process can be stopped so that the path of the brewing piston element in the direction of the filter support is limited, provided by the operation of the locking means.

Coupled to the movement of the hand lever, the brewing piston element can be moved at least into the second position, in which the distributor sieve of the brewing piston element with the filter support delimits the brewing chamber and closes it in a pressure-tight manner. By means of corresponding feed devices, hot pressurized water can be fed into the brewing chamber in a metered and direct manner along a short flow path and pressed through a coffee powder filled into the brewing chamber. For this purpose, a lateral inlet is preferably provided on the brewing piston element for the brewing water generated under pressure by a hot water device. After the brewing water has flowed through the ground coffee, the brewed coffee or espresso can be dispensed downstream of the brewing chamber via an outlet into one or more cups provided.

The actual brewing process can be designed to be variable, whereby the position of the brewing piston element as a closing element for the brewing chamber is able to be adapted to the various coffee preparation methods. In particular, it is provided that the brewing chamber is opened slightly after a first brewing operation. In particular, a defined position or return of the brewing piston element during the build-up of the brewing pressure can be achieved by a suitable design and construction of the locking means. With a minimal adjustable movement of the brewing piston element in the locked position, e.g. in the brewing position, a counterforce can be generated in the locking means, which can be used to press out the coffee cake after the brewing process. The automatic resetting of the brewing piston element initiates a renewed compression of the so-called coffee grounds in order to produce a dry and thus more easily removable coffee cake. In particular, this is based on a certain elasticity of the locking means, which are resiliently reset accordingly when released.

According to a preferred embodiment, the locking means are arranged to form a releasable clamping connection with the brewing piston element. Accordingly, the movement of the brewing piston element can take place largely unhindered in a release position of the locking means, while in a clamping position a movement of the brewing piston element is blocked and is only possible after release of the locking means. In particular, the free movement of the brewing piston element in the direction of the brewing position and a locking in a defined position can be achieved by means of provided activation means.

In one embodiment, the locking means comprise a locking lever that can be pivoted about a horizontal axis and has a fitting bore through which the piston rod is led. In particular, the locking lever can be made of a hardened material and has a certain elasticity. The locking lever is arranged in relation to the brewing piston element and the frame structure so that the piston rod of the brewing piston element extends through a fitting bore provided on the locking lever with little clearance, i.e. the fitting bore closely surrounds the piston rod. The locking lever is mounted at a first end and, starting from this, can be brought in a pivoting direction from a horizontal position into an inclined position in which the brewing piston element is held in position, i.e. in which the piston rod is locked in the fitting bore in a clamping manner. The locking lever is preferably designed in such a way that it is not deformed by the prevailing pressures, and locking of the brewing piston element is possible largely without slippage. In a preferred embodiment, the locking lever comprises at least two mutually parallel plates, which thus enable a kind of stepped locking in the respective fitting bores arranged one above the other.

A second opposite end of the locking lever is free to move so that the locking lever is able to be brought pivotably about its one-sided bearing position from the horizontal position to an inclined position relative to the piston rod. From a certain angular position of the locking lever relative to the piston rod, the piston rod tilts in the fitting bore or bores and the brewing piston element is locked in position by means of a formed friction lock.

Activation means, which interact with the locking lever, are arranged to achieve a locking of the brewing piston element or to release it. The activation means can comprise several functional elements which allow locking on the one hand and release on the other hand, i.e. to release the locking and thus release the brewing piston element.

In one embodiment, the activation means comprise an eccentric arrangement that is operatively connected or can be brought into operative connected with the locking means or the locking lever. In one embodiment, the eccentric arrangement can comprise an eccentric which is designed as a control disk rotatable about a rotary shaft. The eccentric has a circumferential surface with which the locking means can be brought into contact, possibly via transmission elements arranged in between. The eccentric can be rotated around the rotary shaft by means of a, preferably controllable, drive unit. Upon rotation, the circumferential surface configures a trajectory different from a circular arc. When the eccentric rotates about the rotation shaft, the locking lever of the locking means can be brought into sectional contact with the circumferential surface of the eccentric so that the locking lever is brought into an inclined position relative to the piston rod of the brewing piston element. In another rotational position of the eccentric, i.e. when its circumferential surface is not in contact with the locking lever, the latter can be moved out of the inclined position. Alternatively, the transmission means can be provided between the eccentric and the locking lever, which are set up to interact with the locking lever in such a way that it can be moved out of or into its horizontal position. This can be particularly advantageous if the installation situation is limited.

The activation of the activation means can preferably take place by means of a drive unit and can also be regulated or controlled by means of a switching arrangement. By activating the locking means independently of the movement of the hand lever, it is possible to ensure that the brewing piston element is held in defined positions. In one embodiment, the activation means may comprise, in addition to an eccentric arrangement designed as a release means, a spring element which is arranged to activate the locking means. In particular, the spring element can be connected to the second free end of the locking lever so that it moves the locking lever into an inclined position by means of its spring force, while the eccentric provided is arranged to move the locking lever into its horizontal position for release against the spring force. Thus, a very fast activation of the locking means is achieved, whereby a locking of the brewing piston element is independent of the movement of the hand lever.

Furthermore, the present invention relates to an espresso and coffee machine in which the brewing unit according to the present invention can be used. The espresso and coffee machine further comprises a holder in which the filter support is insertable, means for generating and dispensing hot pressurized water and feeding it into a brewing chamber defined by the filter support and a distribution sieve of a brewing piston element of the brewing unit, a grinder for generating coffee powder, and a dosing device for introducing coffee powder into the filter support inserted in the holder.

### BRIEF DESCRIPTION OF FIGURES

An advantageous embodiment of an aspect of the invention will be presented in the following with reference to the drawings, which serve merely explanatory purposes and are not to be interpreted in a limiting way. Features of the invention that become apparent from the drawings should be viewed as belonging to the disclosure of the invention. Shown in the drawings are:

FIG. 1 a schematic sectional representation of a mechanical brewing unit in a first position;

FIG. 2 a schematic sectional representation of a mechanical brewing unit according to FIG. 1 in a second position;

FIG. 3 a schematic sectional representation of a mechanical brewing unit according to FIG. 1 in a third position; and

FIG. 4a detail view of the locking means of the mechanical brewing unit.

### DETAILED DESCRIPTION

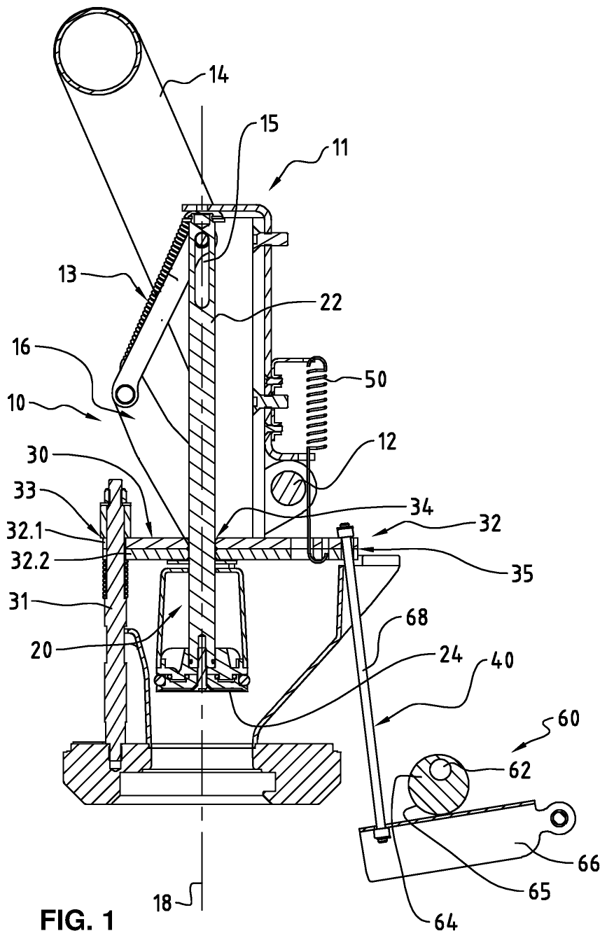

FIG. 1 is a schematic sectional view of a mechanical brewing unit 10, in which, for the sake of simplicity, only those elements are shown which are necessary to explain the operation of the mechanical brewing unit 10.

The mechanical brewing unit 10 comprises a frame structure, of which only a frame section 11 is shown, on which a hand lever 14 is rotatably mounted about an axis of rotation 12. The hand lever 14 can be moved from a starting position, e.g. an upper position, to a lower position, in particular against a resistance force of a return element 13 designed as a spring element. Furthermore, the mechanical brewing unit 10 comprises a brewing piston element 20, which is in operative connection with the hand lever 14 by means of a lever mechanism 16 and is coupled to the movement thereof. The lever mechanism 16 can be designed as a toggle mechanism so that a pivoting movement of the hand lever 14 about the axis of rotation 12 can be transmitted to the brewing piston element 20 via linkage elements of the toggle mechanism. In particular, the movement of the brewing piston element 20 is guided, for example by means of a slide guide 15 provided. Accordingly, the movement of the brewing piston element 20 is coupled to the movement of the hand lever 14, which can be moved accordingly between a first position, as shown in FIG. 1, and at least one second position along a vertical axis 18.

The brewing piston element 20 comprises a piston rod 22 and a distributor sieve 24. The distributor sieve 24 is detachably connected to a lower end of a piston rod 22 and is arranged in such a way that, at least in the second position of the brewing piston element 20, it delimits in a sealing way a brewing chamber (not shown) with a filter support inserted in a holder, whereby corresponding, for example radially acting, sealing means are provided. In the so-called brewing position, hot, pressurized brewing water passes through the distribution sieve 24 into the brewing chamber, where it is forced through the ground coffee filled into the brewing chamber, which is able to be filled into the filter support in the open position.

Furthermore, locking means 30 are provided, which are designed to hold the brewing piston element 20 in an almost continuously adjustable position along the vertical axis 18. This is advantageous if, for example, prior to the actual brewing process, the coffee powder filled into the filter support is tamped or compacted with a definable tamping force.

The locking means 30 are configured to form a releasable clamping connection with the brewing piston element 20. Thus, the brewing piston element 20 is freely movable along the vertical axis 18 in a release position of the locking means 30 and blocked in a position of the locking means 30 referred to as a clamping position.

The locking means 30 comprise a locking lever 32. The locking lever 32 is mounted at a first end 33 on a shaft 31 and has a free second end 35, so that it can be brought out of a horizontal position into an inclined position. In particular, activation means 40, described below, engage a second free end 35 of the locking lever 32.

A fitting bore 34 is provided on the locking lever 32, through which the piston rod 22 of the brewing piston element 20 is guided. In the embodiment according to FIG. 1, the locking lever 32 is formed by two plates 32.1, 32.2 parallel to each other, which can each form a clamping connection with the piston rod 22 in the region of the fitting bore 34. As a result of this multistage feature, multistage locking and resetting is possible.

Activation means 40 are provided for moving the locking means 30 into an inclined position or into a release position. In the embodiment shown, the activation means 40 comprise a spring element 50 which engages the second end 35 of the locking lever 32 and is arranged to move the locking lever 32 into an inclined position by means of its spring force. Accordingly, the brewing piston element 20 is always locked.

An eccentric arrangement 60 is provided for releasing the locking position. In the embodiment shown, this eccentric arrangement 60 comprises an eccentric 64 which is arranged rotatably about a rotary shaft 62 and comprises a circumferential surface 65. The circumferential surface 65 configures, upon rotation about the axis of rotation 62, a trajectory deviating from a circular arc. In the embodiment shown, the circumferential surface of the eccentric 64 is in operative connection with the locking lever 32 by means of a rocker element 66 and a transmission element 68 arranged thereon. Depending on the position of the eccentric 64, the locking lever 32 is moved against the spring force of the spring element 50 into its horizontal position, in which the brewing piston element is released, i.e. the piston rod 22 is freely movable in the fitting bore 34.

In the embodiment shown, the spring element 50 is configured and arranged to immediately place the locking lever 32 in an inclined position when the operative connection between the eccentric 60 and the locking lever 32 is interrupted.

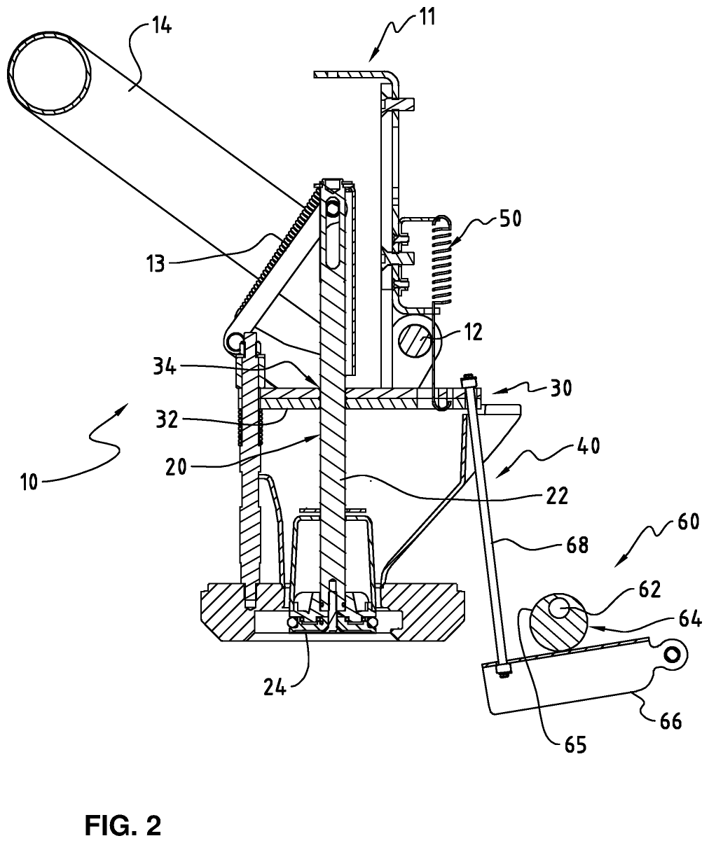

In FIG. 2, the mechanical brewing unit 10 is shown in a second position, whereby it can be seen that the hand lever 14 has moved downwards from the start position and, correspondingly, the brewing piston element 20 has been moved towards the filter support. Also in FIG. 2, the locking means 30 are in a release position in which the piston rod 22 is slidably received in the fitting bore 34. For this purpose, the eccentric arrangement 60 counteracts the spring force of the spring element 50 in such a way that the locking lever 32 is in a horizontal position.

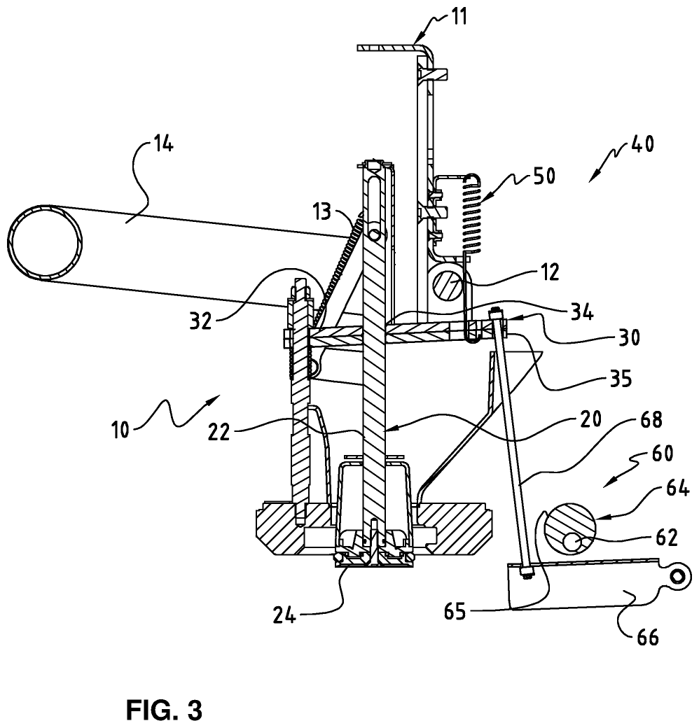

In FIG. 3, the mechanical brewing unit 10 is represented whereby the hand lever 14 is shown in a lower position, whereby the brewing piston element 20 has moved sufficiently into a filter support such that a sealed brewing chamber has been formed with the filter support for the actual brewing operation. In this brewing position, the activating means 40 are activated in such a way that the locking lever 32 is brought into an inclined position and forms a friction lock for the piston rod 22. It can be seen that the eccentric 64 of the eccentric arrangement 60 assumes a rotational position about the axis of rotation 62 in which there is no immediate interaction with the locking lever 32. The spring force of the spring element 50 thus pulls the second free end 35 of the locking lever 32 upward and thus the locking lever 32 assumes an inclined position.

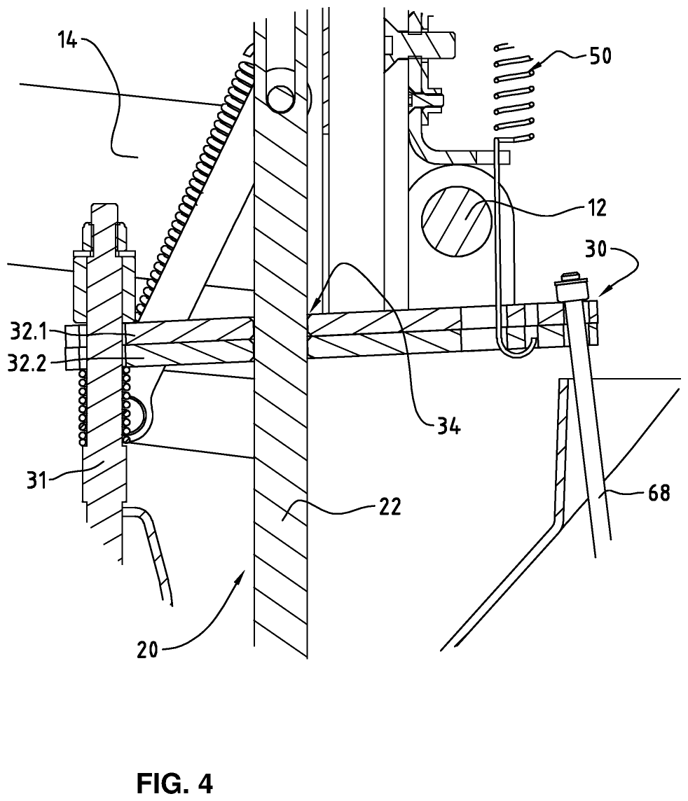

FIG. 4 shows a detailed view of the locking means 30 in a locking position. Here, the spring element engaging the locking lever 32 brings it into an inclined position, whereby at the same time the eccentric 60 is not in operative connection with the locking lever 32. The piston rod guided in the fitting bore 34 is in clamping connection with the first locking plate 32.1 and the second locking plate 32.2, so that a multi-stage clamping effect is achieved.

1. Brewing unit for an espresso and coffee machine, comprising
a frame structure,
a hand lever which is mounted on the frame structure in a way rotatable about an axis of rotation,
a brewing piston element which is operatively connected to the hand lever by means of a lever mechanism, whereby the brewing piston element, coupled to the movement of the hand lever, is movable between a first position and at least one second position along a vertical axis, whereby the brewing piston element comprises
a distributor sieve which, in the second position of the brewing piston element, and together with a filter support which is able to be inserted into a holding device, delimits a brewing chamber, and hot pressurized brewing water is able to be introduced into the brewing chamber through the distributor sieve, and
a piston rod to which the distributor sieve is connectible,
and
locking means are provided, which are designed to hold the brewing piston element in at least one adjustable position along the vertical axis.

2. Brewing unit according to claim 1, wherein the at least one adjustable position corresponds to the second position of the brewing piston element, in which this element is held in a pressing position.

3. Brewing unit according to claim 1, wherein the locking means is arranged to form a releasable clamping connection with the brewing piston element.

4. Brewing unit according to claim 1, wherein the locking means comprises a locking lever borne at a first end (33) and having a fitting bore through which the piston rod is guided.

5. Brewing unit according to claim 4, wherein the fitting bore closely surrounds the piston rod.

6. Brewing unit according to claim 4, wherein the locking lever is able to be brought in a pivoting direction from a horizontal position into an inclined position in which the brewing piston element is held in position.

7. Brewing unit according to claim 4, wherein the locking lever comprises two plates arranged parallel to each other, each having the fitting bore to closely surround the piston rod.

8. Brewing unit according to claim 1, wherein the locking means comprises activating means for activating and/or releasing the locking of the brewing piston element.

9. Brewing unit according to claim 8, wherein the activation means comprises an eccentric arrangement having an eccentric rotatable about a rotary shaft and having a circumferential surface, whereby the circumferential surface configures, upon rotation, a trajectory different from an arc of a circle.

10. Brewing unit according to claim 9, wherein the eccentric is able to be brought into interaction with the locking lever by means of transmission means, so that this locking lever is able to be brought into a release position and/or a locking position as a function of the rotational position of the eccentric.

11. Brewing unit according to claim 9, wherein the eccentric arrangement is able to be activated by means of a controllable drive unit.

12. Brewing unit according to claim 9, wherein the activating means comprises a spring member connectible to the locking lever, the spring member being designed and arranged to move the locking lever into a locking position, and the eccentric arrangement being designed and arranged to move the locking lever into a horizontal position.

13. Espresso and coffee machine, comprising
a brewing unit according to one of the preceding claims,
a holding device into which the filter support is insertable,
means for generating and delivering hot pressurized water and feeding it into a brewing chamber delimited by the filter support and the distributor sieve of the brewing piston element of the brewing unit,
grinder for producing coffee powder, and
a dosing device for introducing coffee powder into the filter support inserted in the holding device.
